(19) United States
(12) Patent Application Publication
(10) Pub. No.: US 2024/0271369 A1
(43) Pub. Date: Aug. 15, 2024

(54) POROUS MEDIA HAVING BIOCIDAL PROPERTIES

(71) Applicant: OBERTHUR FIDUCIAIRE SAS, PARIS (FR)

(72) Inventor: Henri ROSSET, Le Pin (FR)

(21) Appl. No.: 18/559,510

(22) PCT Filed: May 13, 2022
(86) PCT No.: PCT/EP2022/063027

§ 371 Date: Nov. 7, 2023

(30) Foreign Application Priority Data
May 17, 2021 (FR) 21 05125

(51) Int. Cl. D21H 21/36; A01N 25/10; A01N 33/12; A01P 1/00; D21H 11/14; D21H 19/38; D21H 19/46; D21H 19/54; D21H 21/16; D21H 27/10

(52) U.S. Cl. CPC D21H 21/36; A01N 25/10; A01N 33/12; A01P 1/00; D21H 11/14; D21H 19/385; D21H 19/46; D21H 19/54; D21H 21/16; D21H 27/10

(57) ABSTRACT

A biocidal composition for the surface treatment of a porous substrate, the composition having at least one hydrophilic binder, at least one quaternary ammonium-based biocidal compound, and at least one cationic sizing agent. The use of such a composition imparts biocidal, in particular antiviral, properties to a porous substrate.

### TECHNICAL FIELD

The invention relates to the field of porous media having biocidal properties, especially that of sheet materials and more particularly that of fibrous materials such as papers, nonwoven materials, and textiles, especially writing and printing papers, coated papers, copying papers, packaging cardboards produced from virgin and/or recycled fibers, leathers, woods, security papers, security documents, and media for banknotes.

A particular objective of the invention is to provide a composition and a process that are useful for conferring biocidal activity on surfaces and ensuring hydrophobicity in the porous substrates from which these media are derived.

### PRIOR ART

In modern societies, an ever-increasing amount of paper media intended for the conveyance of information, notably banknotes but also media intended for packaging, such as cardboards in particular, is handled daily and frequently by a large number of people.

However, some of these people could be harboring one or more pathogenic microorganisms, the media handled by these people thus becoming a vector for contamination and a generator of epidemic and pandemic diseases of varying seriousness. In this regard, it is also important to point out that a cellulose fibrous material such as a banknote or cardboard generally tends to absorb moisture, which clearly promotes the development of microorganisms therewithin and/or helps keep them viable.

This problem of microbial, bacterial, fungal and/or viral contamination of fibrous, generally cellulose, materials is not new and solutions have already been developed to try to overcome the risk of transmission of microorganisms, bacteria, fungi and/or viruses associated with their mass handling.

The most common solution consists of treating the medium concerned, and more generally the base substrate thereof formed from a cellulose material, with at least one biocidal agent. The incorporation of the biocidal agent(s) into the base substrate may be accomplished by immersing said substrate in a solution of said biocidal agent, or by spraying, surfacing, or coating the substrate with a solution containing said biocidal agent.

Examples of biocidal agents conventionally employed for these purposes include in particular p-[(diiodomethyl)sulfonyl]toluene, 3-iodo-2-propynyl butyl carbamate, methyl 1H-benzimidazol-2-yl carbamate, monolaurin, compounds based on isothiazoline or isothiazolone derivatives, chitosan, quaternary ammonium salts, especially didecyldimethylammonium chloride, silver zinc zeolites, etc. However, these biocidal agents often have only a predominantly specific biocidal activity, i.e. bactericidal, fungicidal or virucidal activity, and it is then necessary to combine them in order to obtain broad-spectrum biocidal efficacy. This is of course an additional constraint, because the conditions for employing these biocidal agents are not always the same. In this respect, compounds based on quaternary ammonium, and didecyldimethylammonium chloride (DDAC) in particular, are known to be particularly advantageous biocidal agents, since they have multiple biocidal properties, in particular antibacterial, antifungal, and antiviral properties (EP2 457 440B).

Unfortunately, compounds based on quaternary ammonium also have the specific feature of being strongly cationic compounds and tend to strongly hydrophilize the substrates in which they are incorporated. Thus, when DDAC is employed with hydrophilic binders such as polyvinyl alcohols or starches and applied to a cellulose substrate, the hydrophobicity of this substrate, which can be quantified by the Cobb water absorption test, decreases, making it no longer possible to achieve for example the required standard of 20 to 40 g/m² for writing and printing papers or for packaging papers. It should also be noted that cellulose media obtained from recycling have the particular feature of being more difficult to hydrophobize than high-grade cellulose media. They are moreover heavily loaded with residual starch-based products and are conducive to microbial development or viability. Their treatment with a biocidal compound based on quaternary ammonium such as DDAC thus exacerbates this problem and this can be enough to thwart the objective of reducing the risk of contamination pursued with this compound, since moisture is favorable to the development of microorganisms.

There therefore remains a need for a surface treatment, especially a coating, for porous substrates, in particular cellulose substrates, that makes it possible to confer upon them biocidal properties, but without altering their hydrophobicity.

There likewise remains a need for a surface treatment, especially a coating, for fibrous substrates resulting from the recycling of high-grade fibrous substrates that is able to simultaneously provide them with biocidal properties and significant hydrophobicity.

The objective of the invention is specifically to provide biocidal protection that is economically acceptable for substrates intended for mass packaging.

Another objective is to provide for the employment of a biocidal agent include in the lists of biocidal products authorized for contact with foods.

A further objective is to ensure lasting antimicrobial activity.

A final objective is to provide a solution with which it is possible to provide, in addition to the desired biocidal character, satisfactory hydrophobicity, especially for substrates intended for mass packaging or for writing and printing.

### DESCRIPTION OF THE INVENTION

The present invention thus proposes a novel biocidal composition for the surface treatment of a substrate.

Thus, according to one of its aspects, the present invention relates to a biocidal composition for the surface treatment of a porous substrate, comprising:
at least one hydrophilic binder,
at least one biocidal compound based on quaternary ammonium, in particular a quaternary ammonium salt, especially didecyldimethylammonium chloride (DDAC), and
at least one cationic sizing agent.

In particular, the biocidal composition comprises at least one biocidal compound based on quaternary ammonium selected from polymeric or non-polymeric quaternary ammonium salts, in particular from non-polymeric quaternary ammonium salts, and more particularly comprises at least didecyldimethylammonium chloride (DDAC).

More particularly, the present invention relates to a biocidal composition for the surface treatment of a porous substrate, comprising:
at least one hydrophilic binder,
at least one biocidal compound based on quaternary ammonium selected from non-polymeric quaternary ammonium salts of the following formula (CH₃)₂A₂N⁺X⁻, where: A, which may be identical or different, represent linear C₆ to C₂₀ alkyl groups, and X⁻ is an anion selected from halide anions and sulfonate anions, and
at least one cationic sizing agent, selected in particular from alkenyl ketene dimers (AnKD), alkyl ketene dimers (AKD), styrene acrylates (SAE), rosins, alkenyl succinic anhydrides (ASA), and mixtures thereof.

In particular, the biocidal compound based on quaternary ammonium comprises at least didecyldimethylammonium chloride (DDAC).

For the purposes of the invention, “surface treatment” refers to the act of forming a deposit of a composition on the surface of a substrate, such that the medium thus obtained has the desired surface biocidal properties and hydrophobicity. In particular, the surface treatment obtained according to the invention results in the formation of a localized coating on the surface of said medium and/or in the surface part of the thickness of the medium.

For the purposes of the invention, the terms “biocidal agent”, or “biocidal”, which are equivalent to the term “antimicrobial agent”, generally denote any agent that is effective in regulating and/or inhibiting the growth and/or reducing the density of microorganisms such as viruses, fungi, bacteria and/or yeasts, etc.

For the purposes of the invention, “cationic sizing agent” refers to a sizing agent formulated in the form of a cationic emulsion, a cationic solution or a cationic dispersion. In emulsion and dispersion formulations, the surface of droplets or particles of the cationic sizing agent is positively charged. A cationic sizing agent can be characterized by a positive zeta potential measurement. The zeta potential can be measured using a device for measuring electrophoretic mobility. A cationic sizing agent can also be characterized by titration of the cationic sizing agent, especially with anionic electrolytes such as anionic polyacrylamides. The titration can be measured using a Mütek PCD device.

As can be seen from the examples below, the inventors have found that the use, in conjunction with a biocidal compound based on quaternary ammonium and especially DDAC, of a particular type of sizing agent in the surface treatment makes it possible against all expectations, to ensure significant hydrophobicity in porous substrates and especially fibrous substrates thus treated, while leaving the expected biocidal properties of the biocidal compound based on quaternary ammonium unaltered.

According to another of its aspects, the present invention relates to a porous medium, in particular a fibrous medium, that has surface biocidal properties and has over all or part of at least one of its outer surfaces a surface treatment and preferably a coating formed from a composition according to the invention. In particular, this porous medium is selected from papers and cardboards, especially cardboards intended for forming packaging cardboards, in particular flat or corrugated cardboards, and for example formed at least in part from recycled fibers.

According to yet another of its aspects, the present invention is aimed at a process for producing, according to the invention, a porous medium having surface biocidal properties, said process comprising at least the steps of:
a) providing a porous substrate, in particular a fibrous substrate, preferably formed at least in part from recycled fibers,
b) bringing all or part of at least one of the outer surfaces of said substrate into contact with a composition according to the invention under conditions conducive to forming a deposit of said composition thereon, and
c) drying said deposit so as to form said porous medium provided with biocidal properties.

According to yet another of its aspects, the present invention provides for the use of a composition of the invention for conferring biocidal properties, especially antiviral properties, on a porous substrate, especially a fibrous substrate.

According to yet another of its aspects, the present invention provides for the use of a composition according to the invention for boosting the hydrophobicity of a porous substrate, especially a fibrous substrate, in particular one formed at least in part from recycled fibers.

According to yet another of its aspects, the present invention provides for the use of a porous medium according to the invention for producing a banknote or a security sheet or a paper for printing, writing or copying.

According to yet another of its aspects, the present invention provides for the use of a porous medium according to the invention for producing a cardboard packaging.

According to yet another of its aspects, the present invention provides for the use of a porous medium according to the invention for producing papers, nonwoven materials, and textiles, writing and printing papers, coated papers, and copying papers.

### DETAILED DESCRIPTION

### Composition According to the Invention

### Biocidal Compound Based on Quaternary Ammonium

Compounds based on quaternary ammonium, in particular quaternary ammonium salts, are known as antimicrobial and/or microbicidal agents, and more particularly as bacteriostatic (or antibacterial) and/or bactericidal and/or fungistatic (or antifungal) and/or fungicidal agents.

They are more particularly a polymeric or non-polymeric quaternary ammonium salt.

The quaternary ammonium salts generally comprise at least one quaternary ammonium cation having a suitable anion X⁻.

The cation is more particularly of the following formula:

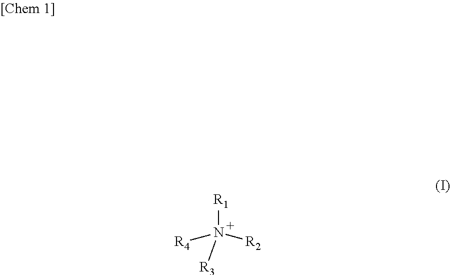

where R₁, R₂, R₃, and R₄ may be a variety of species. For example, R₁, R₂, R₃, and R₄ may be selected independently of one another from alkyl, aryl, alkylaryl, arylalkyl, cycloalkyl, aromatic or non-aromatic heterocyclic, or alkenyl groups, it being possible for said groups to be substituted or unsubstituted, linear or branched, and optionally interrupted by one or more heteroatoms, for example by one or more oxygen atoms, or by one or more phosphinate groups.

Alternatively, two or more of the groups R₁, R₂, R₃, and R₄ may together form, with the nitrogen atom that bears them, a substituted or unsubstituted heterocycle.

According to a particular embodiment, the groups R₁, R₂, R₃, and R₄ are alkyl groups, preferably linear, in particular C₁ to C₂₀, alkyl groups. In particular, the groups R₁, R₂, R₃, and R₄ are saturated, preferably saturated, preferably linear, in particular C₁ to C₂₀, alkyl groups.

The groups R₁, R₂, R₃, and R₄ together contain at least four carbon atoms. In particular, the total number of carbon atoms in the groups R₁, R₂, R₃, and R₄ may be at least 10. Preferably, at least one of the groups R₁, R₂, R₃, and R₄, in particular two of R₁, R₂, R₃, and R₄, contain from 6 to 20 carbon atoms, in particular from 8 to 18 carbon atoms.

The anion X⁻ of the quaternary ammonium salt may be selected in particular from halide anions, for example chloride, fluoride, bromide or iodide, and sulfonate anions. In particular, the anion of the quaternary ammonium salt may be selected from halide anions. Preferably, the anion of the quaternary ammonium salt may be chloride.

The non-polymeric quaternary ammonium salts may more particularly be of the following formula

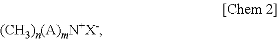

where A has the definition proposed above for R₁, R₂, R₃, and R₄, X⁻ is an anion as defined above, n is an integer between 1 and 3, preferably 2 or 3, m is an integer between 1 and 3, preferably 1 or 2, with the proviso that the sum n+m is equal to 4. When m is 2 or 3, the groups A may be identical or different, in particular identical.

Preferably, the quaternary ammonium salt employed as antimicrobial agent according to the invention may be of the formula (CH₃)ₙ(A)ₘN⁺X⁻, where n is 2, m is 2, and A, which may be identical or different, are as defined above for R₁, R₂, R₃, and R₄.

In particular, A, which may be identical or different, in particular identical, may be linear C₆ to C₂₀, in particular C₈ to C₁₈, especially C₈ to C₁₂, alkyl groups.

In particular, A, which may be identical or different, in particular identical, may be linear saturated C₆ to C₂₀, in particular C₈ to C₁₈, especially C₈ to C₁₂, alkyl groups.

Examples include didecyldimethylammonium chloride (DDAC), dioctyldimethylammonium chloride, and octyldecyldimethylammonium chloride.

The biocidal compound based on quaternary ammonium may also be a polymeric quaternary ammonium salt, i.e. a compound having a chemical formula that contains repeating “quaternary ammonium” units.

Such a “polymeric” quaternary ammonium salt may be derived from at least one compound of the formula (I) in which at least one of R₁, R₂, R₃, and Ra bears a polymerizable function, in particular a function containing ethylenic unsaturation(s) and more particularly selected from (meth)acrylate and allyl functions.

In particular, this “polymeric” compound based on quaternary ammonium may be obtained by polymerizing at least one aforementioned quaternary ammonium salt of the formula (I), in which two of R₁, R₂, R₃, and R₄ are groups bearing an allyl function, in particular are allyl groups, the others being preferably alkyl groups, in particular C₁ to C₆, especially C₁ to C₄, in particular methyl, groups.

According to a particular embodiment, this polymeric compound based on quaternary ammonium is a homopolymer of diallyldialkylammonium chloride. In particular, it may be the polymer of diallyldimethylammonium chloride termed polyDADMAC. The polyDADMAC may be synthesized by free-radical polymerization of DADMAC in the presence of a peroxide as catalyst or it may be commercially available.

According to a particular embodiment, a biocidal composition according to the invention employs at least didecyldimethylammonium chloride (DDAC).

As specified above, the inventive biocidal compositions comprise from 0.05% to 2.5% by dry weight, preferably from 0.25% to 1.5% by dry weight, and more preferably from 0.25% to 1% by dry weight, of biocidal compound(s) based on quaternary ammonium, selected especially from polymeric or non-polymeric quaternary ammonium salts, in particular from non-polymeric quaternary ammonium salts, and more particularly didecyldimethylammonium chloride (DDAC), relative to the total weight thereof.

For the purposes of the invention, “dry weight”, also referred to as “weight of active ingredient” denotes, unless otherwise stated, the content by weight of said compound, not including any volatile solvents in which it is formulated, for example water.

In particular, the amount of biocidal compound(s) based on quaternary ammonium, especially of DDAC, is adjusted in the composition such that the surface treatment, and preferably the coating formed from the composition, comprises less than 10% by dry weight and preferably less than 5% by dry weight of biocidal compound(s) based on quaternary ammonium, and of DDAC in particular, relative to the total dry weight thereof.

As can be seen from the examples hereinbelow, a porous medium obtained according to the invention advantageously has, after a contact time of 5 hours with the human coronavirus strains HcoV-229E and HcoV-OC43 according to standard ISO 21702:2019 or ASTME 1093, good to excellent antiviral activity according to the criteria of standard ISO 18184:2019-06, Annex 5 and, most particularly, very strong antiviral activity against viruses of the enveloped virus family, with activities of 2.5- and 3-1-log reduction in viral titer.

### Cationic Sizing Agent

As detailed below, the combination of such a sizing agent with the biocidal compound based on quaternary ammonium, in particular with a quaternary ammonium salt such as DDAC, makes it possible to significantly neutralize the negative effect of said compound based on quaternary ammonium on the hydrophobicity of the porous substrate to be treated. Hydrophobicity is characterized as resistance to water penetration and is therefore measured using the Cobb test (60 s). This is the amount of water absorbed by the medium in g/m² using a cylindrical impregnation template over a time period of 60 seconds. It is a test conventionally used in the paper industry to characterize the absorption of paper.

In particular, said cationic sizing agent may be selected from acrylonitrile, alkenyl ketene dimers (AnKD), alkyl ketene dimers (AKD), styrene acrylates (SAE), rosins, alkenyl succinic anhydrides (ASA), and mixtures thereof.

In particular, said cationic sizing agent may comprise at least one compound selected in particular from acrylonitrile, alkenyl ketene dimers (AnKD), alkyl ketene dimers (AKD), styrene acrylates (SAE), rosins, alkenyl succinic anhydrides (ASA), and mixtures thereof. More particularly, said cationic sizing agent comprises at least one alkyl ketene dimer (AKD) and/or one styrene acrylate (SAE) and more preferably comprises at least one alkyl ketene dimer (AKD).

In particular, said cationic sizing agent comprises at least one styrene acrylate (SAE).

This may in particular be the surface sizing agent of the cationic alkyl ketene dimer type such as are sold by Solenis under the name Aquapel™ J 215 (AKD) or alternatively the surface sizing agent of the cationic styrene acrylate (SAE) type such as are sold by Solenis under the name Basoplast 270D.

In particular, the cationic sizing agent is distinct from the biocidal compound based on quaternary ammonium employed in the composition according to the invention. In particular, the cationic sizing agent is distinct from a quaternary ammonium salt.

A composition according to the invention may especially comprise from 0.5% to 5% by weight, preferably from 1% to 4% by weight, and more preferably from 1% to 3% by weight, of commercial cationic sizing agent product(s) relative to the total thereof.

In particular, the biocidal compound based on quaternary ammonium, and preferably didecyldimethylammonium chloride, and the cationic sizing agent(s) may be employed in a composition according to the invention in a weight ratio of dry weight of compound(s) based on quaternary ammonium/weight of commercial cationic sizing agent product(s) ranging from 0.1 to 0.5, preferably from 0.25 to 0.375, and more preferably from 0.25 to 0.33.

According to a particular embodiment, a composition according to the invention may comprise from 0.08% to 1.5% by dry weight, preferably from 0.17% to 1.2% by dry weight, and more preferably from 0.17% to 0.9% by dry weight, of cationic sizing agent(s) relative to the total weight thereof.

According to a particular embodiment, the biocidal compound based on quaternary ammonium, and preferably didecyldimethylammonium chloride, and the cationic sizing agent(s) may be employed in a composition according to the invention in a weight ratio of dry weight of compound(s) based on quaternary ammonium/dry weight of cationic sizing agent(s) ranging from 0.25 to 5.9, in particular from 0.3 to 3.6, preferably from 0.8 to 2.5, and more preferably from 0.8 to 2.2.

As can be seen from the examples hereinbelow, a porous medium obtained according to the invention advantageously has a Cobb value of not more than 50 g/m², preferably of from 20 to 40 g/m², measured with the Cobb test carried out according to standard ISO 535:2014 over a period of 60 s.

### Binding Agent

In addition to the biocidal compound based on quaternary ammonium, especially one as defined above, in particular a quaternary ammonium salt such as DDAC, and at least one cationic sizing agent, especially one as defined above, a composition according to the invention comprises at least one hydrophilic binder. This binder is referred to as hydrophilic on account of its affinity for water and therefore for aqueous media.

In particular, this binding agent may be selected from polyvinyl alcohols, starches, latexes, especially acrylic or acrylic copolymer latexes, hemicelluloses, carboxymethylcelluloses (CMCs), galactomannans, gelatins, polyurethane dispersions, and mixtures thereof.

More particularly, this binding agent comprises at least one polyvinyl alcohol and/or one starch and more preferably comprises at least one starch.

This may be for example potato starch, especially oxidized potato starch, wheat starch or corn starch.

Thus, a composition according to the invention may comprise from 1% to 50% by dry weight, preferably from 2% to 40% by dry weight, and more preferably from 2% to 20% by dry weight, of hydrophilic binder(s) relative to the total weight thereof.

In addition to these three essential compounds, a composition according to the invention may of course comprise an aqueous solvent, especially water, and any other compounds conventionally considered for the surface treatment of porous substrates but also with regard to the biocidal activity desired according to the invention.

### Auxiliary Biocidal Agent

Thus, a composition according to the invention may comprise one or more bacteriostatic, bactericidal, fungistatic, fungicidal, levuricidal or virucidal agent other than a biocidal compound based on quaternary ammonium.

These agents are of course also selected for their harmlessness to humans under the conditions of use according to the invention.

These one or more auxiliary biocides may especially be selected from p-[(diiodomethyl)sulfonyl]toluene, 3-iodo-2-propynyl butyl carbamate, methyl-1H-benzimidazol-2-yl carbamate, monolaurin, compounds based on isothiazoline or isothiazolone derivatives, on chitosan or chitin derivatives, on zinc zeolite, on silver ions, especially silver chloride, on silver in supported particulate form, and on triclosan, and mixtures thereof.

According to one variant, a composition according to the invention comprises at least one bacteriostatic and/or bactericidal agent selected from compounds based on chitosan or chitin derivatives, on zinc zeolite, on silver ions, on silver in supported particulate form, and on triclosan, and mixtures thereof.

According to one variant, a composition according to the invention comprises at least one fungistatic and/or fungicidal agent selected from compounds based on isothiazoline or isothiazolone derivatives, on chitosan or chitin derivatives, on zinc zeolite, on silver ions, on silver in supported particulate form, and on triclosan.

According to one variant, a composition according to the invention comprises at least one fungistatic and/or fungicidal agent based on p-[(diiodomethyl)sulfonyl]toluene.

According to one variant, a composition according to the invention comprises at least one fungistatic and/or fungicidal agent based on methyl-1H-benzimidazol-2-yl carbamate.

According to a preferred variant, a composition according to the invention comprises at least 3-iodo-2-propynyl butyl carbamate (IPBC).

According to another variant, a composition according to the invention comprises at least one virucide, especially one of natural origin.

For the purposes of the present invention, the term “virucide” means any compound having the ability to kill or inhibit viruses.

The virucide according to the present invention is more particularly intended for killing and/or inhibiting a virus that is pathogenic to mammals and more particularly to humans. Such viruses may be non-enveloped or enveloped viruses.

Examples of viruses that are pathogenic to humans and that may be considered according to the invention include more particularly retroviruses, cytomegaloviruses, rotaviruses, paramyxoviruses, polioviruses, hantaviruses, coxsackie viruses, encephalomyocarditis virus, picornaviruses, including rhinoviruses, DNA or RNA viruses, especially flaviviridae, the AIDS virus, flu viruses and especially H1N1, coronaviruses and especially the human coronaviruses Hcov-229E, Hcov-0C43, SARS-COV-2, smallpox virus, yellow fever virus, hepatitis C virus, Ebola viruses, herpes viruses, Epstein-Barr virus, varicella zoster virus, rubella virus, or simian virus 40 or SV40.

“Virucide of natural origin” refers to any virucide that already exists in nature or that can be synthesized from natural compounds that exist in nature.

The virucides of natural origin that can be used in the context of the present invention can thus be obtained either by extraction and purification from a natural medium that contains them or by synthesis from natural compounds.

Examples of such virucides include in particular monolaurin, which can be obtained by synthesis from glycerol and lauric acid.

For the purposes of the invention, the term monolaurin refers both to naturally pre-existing monolaurin and that obtained by synthesis from glycerol and lauric acid.

According to one embodiment, the virucide of natural origin may especially be selected from monolaurin, lactoferrin, and essential oils that have antiviral activity, for example essential oil of bay.

By way of illustration, a composition of the invention may comprise from 0.1% to 2.0% by dry weight, for example from 0.5% to 1.5% by dry weight, of virucide(s) of natural origin, relative to the total dry weight thereof.

In a preferred embodiment, the auxiliary biocide is at least monolaurin.

According to another particular embodiment, a composition according to the invention comprises at least one filler, especially a mineral filler.

Such a component is especially advantageous for conferring enhanced surface qualities on the surface treatment formed by the composition according to the invention and especially for improving its coefficient of friction.

This filler may be selected from mineral fillers, especially colloidal silica, sodium silicates, sodium aluminosilicates, natural or precipitated calcium carbonates, talc, natural or calcined kaolin, alumina hydrate, titanium dioxide, aluminum silicates, barium sulfate, and mixtures thereof, and from organic fillers, especially plastic fillers or pigments. Preferably, a composition according to the invention comprises at least one mineral filler and in particular calcium carbonate.

A composition according to the invention may thus comprise from 0.1% to 5% by weight, preferably from 0.1% to 1% by weight, of filler(s), especially mineral filler(s), relative to the total weight thereof.

### Porous Medium According to the Invention and Process for the Production Thereof

### Porous Medium

As can be seen from the above, the invention also provides a porous medium in which all or part of one of its external surfaces has been treated with a composition of the invention, and in particular so as to form a coating thereon.

This porous medium may advantageously be fibrous, especially of the paper or cardboard type, and in particular a cardboard intended for forming packaging cardboard, said cardboard being formed of virgin fibers or preferably at least in part or wholly of recycled fibers.

A fibrous substrate suitable for producing this medium is formed especially from fibers that may be natural, artificial and/or synthetic. It may also contain mineral fillers.

According to one embodiment of the invention, the fibers used in the composition of the substrate comprise natural fibers.

Natural fibers include cellulose fibers, such as wood fibers, for example hardwood fibers, softwood fibers or a mixture thereof, cotton fibers, bamboo fibers, straw fibers, abaca fibers, esparto fibers, hemp fibers, jute fibers, flax fibers, sisal fibers, and mixtures thereof.

The paper pulp used to form the paper or cardboard may be bleached, semi-bleached or non-bleached, commonly referred to respectively as bleached, semi-bleached or non-bleached fibers.

Preferably, the fibers used in the composition of the substrate comprise cellulose fibers, in particular cotton fibers.

In particular, said cellulose fibers are a mixture of cotton fibers and wood fibers.

According to an advantageous variant, this substrate is formed at least in part or even for the most part of recycled fibers, for example fibers originating from the trituration of wastepaper.

According to another embodiment of the invention, the fibers used in the composition of the substrate may comprise synthetic fibers. The presence of synthetic fibers blended with cellulose fibers in the substrate according to the invention makes it possible to improve the tear-resistance properties of said substrate.

In addition to these fibers, the porous, and more particularly fibrous, substrate may of course contain other components commonly used in the paper or cardboard industry and selected especially from humectant agents, for example compounds of the polyol type, for example glycerol, also called glycerin, propylene glycol, polyethylene glycol, butylene glycol, glyceryl triacetate, or sorbitol; fillers, especially ones such as those defined above, and anionic or cationic bulk sizing agents, for example ones intended to develop some of the hydrophobicity of the finished substrate.

In a preferred embodiment, the porous medium obtained according to the invention is a fibrous paper or cardboard medium for banknotes or security documents or a packaging paper, or a copying paper or a card support for the production of packaging cardboards, especially cardboards intended for forming packaging cardboards, in particular flat or corrugated cardboards. The porous medium may also be a leather or a wood surface treated according to the invention.

### Process for Producing a Porous Medium

In the process according to the invention, at least one of the external surfaces of the porous substrate concerned is brought into contact with a composition according to the invention under conditions conducive to forming a deposit of said composition thereon, and the deposit thus obtained is dried to form the expected porous medium.

The drying step may especially be carried out at a temperature greater than or equal to 80° C., for example greater than or equal to 90° ° C., preferably greater than or equal to 100° C.

This contacting step may be carried out according to different variants.

The formation of the deposit may be carried out according to different methods of application of the composition.

According to one embodiment, the fibrous substrate is immersed in a solution containing at least the composition according to the invention.

According to another embodiment, a solution containing at least the composition according to the invention is sprayed onto the surface of at least one side of the substrate.

According to another embodiment, at least one of the external surfaces of the substrate is coated using a coating solution containing at least the composition according to the invention. The coating may be done by means of an air knife system, a curtain coater, by means of a pencil, knife or doctor blade system, by means of rollers, in particular predosed, engraved or transfer rollers, by means of a size press, by means of an impregnator, or by means of a film press.

According to another embodiment, at least one of the external surfaces of the substrate is surfaced with a surfacing bath containing at least the composition according to the invention. According to another embodiment, the porous substrate, after having undergone prior coating and/or surfacing, is printed on part or all of its surface using an ink containing at least the composition according to the invention.

According to another embodiment, an overprint varnish containing at least one composition according to the invention is applied to at least one of the external surfaces of said porous substrate, preferably after this has undergone prior coating and/or surfacing and printing. It can be applied by flexography, rotogravure or spraying.

These embodiments are particularly advantageous insofar as their implementation is compatible with a conventional process for producing a porous medium, in particular a fibrous medium, especially of paper type, that is to say concomitantly with conventional production steps.

It therefore advantageously does not necessitate any additional step other than those required for the production of the medium.

These different methods of bringing the composition into contact with the external surface(s) of the substrate to be treated may of course be combined where appropriate. However, such combinations must be compatible with the substrate exhibiting the desired biocidal activity and hydrophobicity.

### Applications

The present invention relates to the use of a porous medium, especially a fibrous medium according to the invention, for producing papers, for coverings (kraftliner or testliner) and/or paper for corrugated materials used in the composition of packaging cardboards.

The present invention also relates to the use of a porous medium according to the invention for producing a banknote or a security document.

The banknote, security document or cardboard packaging according to the invention has the same properties as the porous medium according to the invention, measured according to the characterization methods defined for this fibrous medium.

The present invention relates also to the use of a porous medium according to the invention for producing papers, nonwoven materials, and textiles, writing and printing papers, coated papers, and copying papers.

According to one embodiment, the porous medium according to the invention is intended for forming a security sheet that incorporates at least one security element allowing the authentication of said sheet. In particular, said security element is selected from visual devices, in particular optical variable devices, referred to as OVDs, holograms, lenticular devices, elements having an interference effect, in particular iridescent elements, liquid crystals, pigments having a magnetically orientable effect, and multilayer interference structures. These optical variable devices may be present on security threads incorporated into the fibrous substrate or on strips or patches affixed or printed on the fibrous substrate. Other visual security elements include watermarks created during the process for producing the fibrous substrate. In particular, said security element is selected from what are known as luminescent elements; these luminescent elements can be revealed under UV or IR and may be in the form of security particles, security fibrets, security planchets or security thread incorporated into at least part of the fibrous substrate, or of strips or patches affixed or printed on the fibrous substrate. In particular, said security element is selected from elements that can be detected in an automated process, especially optically or magnetically, these detectable elements, commonly termed markers or taggants, being incorporated into the fibrous medium or into visual or luminescent security elements. A security sheet may also include a radio frequency identification device, referred to as a RFID, which also provides the security sheet with an identification and traceability function.

According to one embodiment, the security sheet considered according to the invention is a security document or forms part thereof. Preferably, the security document considered according to the invention is an official document, in particular an identity document, a passport, a residence permit or a visa.

According to another embodiment, the porous medium according to the invention may be intended for forming a driver's license, an access card, a loyalty card, a photocopy card, a canteen card, a playing card, a collectible card, a means of payment, especially a payment card, banknote, voucher or receipt, a ticket for cultural or sporting events, a certificate of authenticity, a book or a magazine.

The following non-limiting examples will make it possible to better understand how the invention can be put into practice and the advantages thereof.

### Examples

### Material and Methods

The following raw materials were used:
Bath of carboxylated potato starch sold by Avebe under the name Perfectamyl P 255SH and having an AI content of 8% or 10%;
Wheat starch;
Corn starch;
Bulk sizing agent of the cationic styrene acrylate type sold by Kemira under the name Fennosize KD 860D and having an active ingredient content of 26.5%;
Surface sizing agent of the cationic styrene acrylate (SAE) type sold by Solenis under the name Basoplast 270D and having an active ingredient content of 30%;
Surface sizing agent of the cationic alkyl ketene dimer type sold by Solenis under the name Aquapel™ J 215 (AKD) and having a 15% content of the active ingredient AKD;
Didecyldimethylammonium chloride (DDAC) sold as a solution having a 50% content of the active ingredient DDAC by Thor, Stepan Europe, and Lonza;
Solution of 3-iodo-2-propynyl butyl carbamate (IPBC) sold by Thor and having a 20% content of the active ingredient IPBC;
Calcium carbonate sold by Omya under the name Hydrocarb 90 OG.

In the examples that follow, percentages by weight are unless otherwise stated expressed as percentages by weight of the commercial products that are the source of the compounds according to the invention.

### 1. Test to Evaluate Hydrophobicity

The Cobb test carried out according to ISO 535:2014, over a period of 60 s, permits the characterization of the absorption of water by the sample.

### 2. Test to Evaluate Wet Recovery

This objective of this test is to determine the weight of bath taken up during the coating/surfacing step by weighing the paper before and after coating/surfacing, without carrying out drying. It is expressed in grams of wet coating applied per unit area (m²) or in % by weight.

### 3. Test of Antifungal Properties

These are characterized by means of a fungistatic control according to textile standard AATCC-30 Test 3 using Aspergillus niger van Thiegem (DSM 1957) and according to AFNOR standard NFX41517 using a mixture of 10 strains and a contact time of 14 days.

### 4. Test of Antiviral Properties

All tests carried out with the coronavirus strain HcoV-229E are carried out according to standard ISO 21702:2019, but with a contact time of 5 h.

All tests carried out with the coronavirus strain OC43 (ATCC VR-1558) are carried out according to standard ASTM E1053, but with a contact time of 5 h.

All tests carried out with the bacteriophage MS2 are carried out according to standard ISO18184:2019-06, but with a contact time of 18 h.

The results, expressed as log values, correspond to the reduction in viral load for the respective contact times versus a reference without antimicrobial treatment.

### 5. Measurement of the Coefficient of Friction

The coefficient of friction is determined according to standard NF Q03-82 March 1984.

### Example 1: Production of Inventive and Noninventive Biocidal Compositions

The starch bath is produced by cooking for 20 min at 90° C. an aqueous starch composition of the carboxylated potato starch type (Perfectamyl P 255SH).

Inventive compositions 1 and 2 are produced from this starch bath into which is mixed the respective surface sizing agent. Once a homogeneous mixture has been obtained, DDAC and, where appropriate, IBPC are added to the bath.

Control compositions 3 to 5 are produced in the same way.

The proportions used are indicated in Table 1.

TABLE 1

| | 1 | 2 | 3_{Control} | 4_{Control} | 5_{Control} |
|---|---|---|---|---|---|
| | (parts by | (parts by | (parts by | (parts by | (parts by |
| Composition | weight) | weight) | weight) | weight) | weight) |
| Bath of starch | 100 | 100 | 100 | 100 | |
| containing 8% by | | | | | |
| weight of starch | | | | | |
| (Perfectamyl P | | | | | |
| 255SH) | | | | | |
| Bath of starch | | | | | 100 |
| containing 10% by | | | | | |
| weight of starch | | | | | |
| (Perfectamyl P | | | | | |
| 255SH) | | | | | |
| Sizing agent | 3 | 3 | — | — | — |
| Basoplast 270D | | | | | |
| containing 30% by | | | | | |
| weight of AI | | | | | |
| Commercial solution | 1 | 1 | — | 1.5 | 1.5 |
| of DDAC containing | | | | | |
| 50% by weight of AI | | | | | |
| Commercial solution | — | 2.6 | — | — | — |
| of IPBC containing | | | | | |
| 20% by weight of AI | | | | | |

### Example 2: Production of Inventive and Noninventive Porous Media by Treatment of a Substrate Based on Recycled Pulp

Porous substrates are produced according to a conventional papermaking process from a recycled pulp composed of 100% recycled cardboard fibers, with or without incorporation therein of the cationic styrene acrylate type bulk sizing agent Fennosize KD 860D, the content of which is expressed in Table 2 as % by weight of commercial product relative to dry matter weight of the recycled pulp. The substrates have a grammage of 160 g/m². The substrates obtained then undergo surfacing in a size press with various compositions as detailed in example 1.

TABLE 2

| | | | Control | Control | Control |
|---|---|---|---|---|---|
| | Test A | Test B | C | D | E |
| Bulk sizing agent | 4% | 4% | 4% | 4% | — |
| (Fennosize 860D) | | | | | |
| Composition | 1 | 2 | 3_{Control} | 4_{Control} | 5_{Control} |
| | (parts by | (parts by | (parts by | (parts by | (parts by |
| | weight) | weight) | weight) | weight) | weight) |
| Bath of starch | 100 | 100 | 100 | 100 | |
| containing 8% by | | | | | |
| weight of starch | | | | | |
| (Perfectamyl P | | | | | |
| 255SH) | | | | | |
| Bath of starch | | | | | 100 |
| containing 10% by | | | | | |
| weight of starch | | | | | |
| (Perfectamyl P | | | | | |
| 255SH) | | | | | |
| Sizing agent | 3 | 3 | — | — | — |
| Basoplast 270D | | | | | |
| containing 30% by | | | | | |
| weight of AI | | | | | |
| Commercial solution | 1 | 1 | — | 1.5 | 1.5 |
| of DDAC containing | | | | | |
| 50% by weight of AI | | | | | |
| Commercial solution | — | 2.6 | — | — | — |
| of IPBC containing | | | | | |
| 20% by weight of AI | | | | | |
| Characterization of | 0.323% | 0.266% | | 0.493% | 0.715% |
| % by dry weight of | | | | | |
| DDAC relative to | | | | | |
| total weight of | | | | | |
| surfaced paper | | | | | |
| Cobb (g/m²) | 54 | 67 | 30 | 186 | 230 |
| Wet recovery (g/m²) | 100 | 85 | 54 | 100 | 136 |
| AATCC30 | 1.4 | 0 | — | 0 | 4 |
| NFX41517 | 4 | 1 | — | 0.8 | — |
| Hcov-229^{E} | 2.5-log | 2.5-log | — | — | — |
| Bacteriophage MS2 | −0.76-log | 0.34-log | — | — | 0.84-log |

As can be seen from these results detailed below, a composition of the invention, such as those in tests A and B, makes it possible to obtain an advantageous trade-off between the hydrophobicity properties and biocidal activity of the paper.

Thus, on comparing control tests C and D it can be seen that the Cobb value increases sharply from 30 g/m² to 186 g/m² when DDAC is present in the composition used for surfacing the fibrous substrate, which is therefore indicative of hydrophilization of the fibrous substrate by DDAC.

However, comparing test A and control test D shows that the use of composition 1 of the invention significantly reduces the Cobb value and therefore brings about a gain in hydrophobicity for a recycled paper. This same advantageous result is verified with test B. Moreover, the two media obtained according to tests A and B have very strong antiviral activity against Coronavirus HcoV-229^{E}, a strain representative of the enveloped viruses, with a value of 2.5 log.

Finally, comparing the media obtained according to tests A and B demonstrates an improvement in antifungal activity when IPBC is added to composition A.

### Example 3: Production of Inventive and Noninventive Porous Media from a Substrate Based on Recycled Pulp

Fibrous substrates are produced from a high-grade pulp composed of 80% bleached softwood fibers and 20% eucalyptus kraft pulp, with or without incorporation therein of the cationic styrene acrylate type bulk sizing agent Fennosize KD 860D, the content of which is expressed in Table 3 as % by weight of commercial product relative to dry matter weight of the recycled pulp. The substrates thus obtained then undergo surfacing according to the process described in example 2, with one of the compositions detailed in Table 3 below.

TABLE 3

| | Test F | Test G | Control H |
|---|---|---|---|
| Bulk sizing agent | 1.75% | 1.75% | 1.75% |
| (Fennosize 860D) | | | |
| Composition | 1 | 2 | — |
| | (parts by | (parts by | |
| | weight) | weight) | |
| Bath of starch containing 8% | 96 | 93.4 | — |
| by weight of starch | | | |
| (Perfectamyl P 255SH) | | | |
| Sizing agent Basoplast 270D | 3 | 3 | — |
| containing 30% by weight of | | | |
| AI | | | |
| Commercial solution of | 1 | 1 | — |
| DDAC containing 50% by | | | |
| weight of AI | | | |
| Commercial solution of IPBC | — | 2.6 | — |
| containing 20% by weight of | | | |
| AI | | | |
| Characterization of % by dry | 0.258 | 0.250 | — |
| weight of DDAC relative to | | | |
| total weight of surfaced paper | | | |
| Cobb (g/m²) | 30 | 31 | 30 |
| Wet recovery (g/m²) | 64 | 62 | |
| AATCC30 | 0 | 0 | 4 |
| NFX41517 | 2.5 | 0 | 4 |

Comparing the tests according to the invention F and G with the control test H shows that the substrates treated with compositions 1 and 2 of the invention have a Cobb value identical to the Cobb value of the substrate not treated by surfacing, despite the presence of DDAC. Thus, the combination of a surface sizing agent such as a cationic styrene acrylate with DDAC makes it possible to restore the hydrophobicity of the DDAC-free fibrous substrate. Comparing the tests according to the invention with the control test also demonstrates an improvement in the antifungal activity obtained by surfacing the fibrous substrate with a composition of the invention, both according to the AATCC30 standard and according to the NFX41517 standard. It can also be noted that the antifungal activity is further improved by the presence of IPBC in the composition according to the invention, as demonstrated by test G.

### Example 4: Production of Inventive and Noninventive Biocidal Compositions

Compositions 6 to 10 that follow are produced according to the protocol already specified in example 1 using cooked wheat starch, and Table 4 shows the proportions of their various components.

In the case of the inventive composition 10, the CaCO₃ is first incorporated into the starch bath and stirring prolonged until it has dispersed before adding the other compounds. Each of the compositions is applied to one side of a fibrous paper substrate having a grammage of 160 g/m² based on non-recycled pulp and having a bulk sizing. Such a substrate is conventionally used for packaging cardboards. Surfacing is carried out according to a pencil application process. Each of the coatings is then analyzed in respect of its hydrophobic properties as described above and the measured values are shown in Table 4 below.

TABLE 4

| | Control I | Control J | Test K | Test L | Test M |
|---|---|---|---|---|---|
| Composition | 6 | 7 | 8 | 9 | 10 |
| | (parts by | (parts by | (parts by | (parts by | (parts by |
| | weight) | weight) | weight) | weight) | weight) |
| Bath of starch | 100 | 99 | 97.5 | 96.5 | 97 |
| containing 14.5% by | | | | | |
| weight of cooked | | | | | |
| wheat starch | | | | | |
| Sizing agent Aquapel | — | — | 1.5 | 2.5 | 1.5 |
| J215 containing 15% | | | | | |
| by weight of AI | | | | | |
| Commercial solution | — | 1 | 1 | 1 | 1 |
| of DDAC containing | | | | | |
| 50% by weight of AI | | | | | |
| Calcium carbonate | — | — | — | — | 0.5 |
| (Hydrocarb 90 OG) | | | | | |
| Wet recovery (g/m²) | 4.3 | 4.7 | 4.3 | 4.6 | 4.5 |
| Cobb (g/m²) | 34.3 | 40.6 | 35.8 | 33.4 | 38.0 |

These results confirm the effect of the presence of DDAC on the hydrophobicity (control J versus control I) and the effectiveness of the cationic sizing agent in restoring this hydrophobicity (tests K to M versus control tests).

The antiviral activity is measured for test M with the strain Coronavirus OC43 according to the method described in the Materials and methods section. The obtained reduction in viral load is 3.1-log relative to the reference fibrous substrate without antimicrobial treatment. The compositions according to the invention are therefore found to confer effective antiviral protection on the fibrous substrate.

Test M also reveals that the medium treated with composition 10, which also contains calcium carbonate, advantageously has an improved coefficient of friction relative to that observed for test K.

### Example 5: Production of an Inventive Biocidal Composition

An aqueous starch bath is first produced from 11.4% by weight of cooked corn starch and the totality is heated to 65° C. until a homogeneous mixture is obtained.

A composition 11 comprising 96.5% by weight of this bath of cooked corn starch, 3.9% by weight of a surface sizing agent Aquapel J 215 having an AI content of 15% by weight, and 0.5% by weight of a DDAC solution having a DDAC content of 50% by weight is then produced according to a protocol similar to that described in example 1.

This composition 11 is deposited by surfacing in a size press on a 190 g/m² recycled pulp paper. The dry deposition is 9.5 g/m².

The Cobb value obtained according to the method detailed in the Materials and methods section is 49.2 g/m². The reduction in viral load with the strain Coronavirus HCoV-229E according to the method described in the Materials and methods section is 1.6-log relative to the reference fibrous substrate without antimicrobial treatment.

The antiviral protection and hydrophobicity expected are indeed observed.

### Example 6: Production of an Inventive Biocidal Composition

A composition 12 is produced that comprises 96% by weight of the commercial product Mowiol 10-98 having a polyvinyl alcohol content of 7.8% by weight, 2% by weight of a solution of a DDAC solution having a DDAC content of 80% by weight, 1.5% by weight of Basoplast 270D surface sizing agent having an AI content of 30% by weight, and 0.5% by weight of the commercial product Fennostrength XO (PAE resin).

This composition 12 thus formed is then deposited by surfacing in a size press on a 115 g/m² paper produced from unbleached kraft pulp. The dry deposition is 1.8 g/m².

The Cobb value measured according to the method detailed in the Materials and methods section is 42 g/m². The viral load evaluated with the strain Coronavirus OC43 according to the method described above is greater than 3-log relative to the reference fibrous substrate without antimicrobial treatment.

The antiviral protection and hydrophobicity expected are indeed observed.

1. A biocidal composition for the surface treatment of a porous substrate, comprising:
at least one hydrophilic binder,
at least one biocidal compound based on quaternary ammonium selected from non-polymeric quaternary ammonium salts of the following formula (CH₃)₂A₂N⁺X⁻, where:
A, which may be identical or different, represent linear C₆ to C₂₀ alkyl groups, and
X⁻ is an anion selected from halide anions and sulfonate anions, and
at least one cationic sizing agent.

2. The composition as claimed in claim 1, comprising at least didecyldimethylammonium chloride (DDAC), dioctyldimethylammonium chloride or octyldecyldimethylammonium chloride.

3. The composition as claimed in claim 1, comprising at least one cationic sizing agent comprising at least one alkyl ketene dimer (AKD) and/or one styrene acrylate (SAE).

4. (canceled)

5. The composition as claimed in claim 1, comprising at least one hydrophilic binder selected from polyvinyl alcohols, starches, latexes, hemicelluloses, carboxymethylcelluloses (CMCs), galactomannans, gelatins, polyurethane dispersions, and mixtures thereof.

6. The composition as claimed in claim 1, comprising from 1% to 50% by dry weight of hydrophilic binder(s) relative to the total weight thereof.

7. The composition as claimed in claim 1, comprising from 0.05% to 2.5% by dry weight of biocidal compound(s) based on quaternary ammonium relative to the total weight thereof.

8. The composition as claimed in claim 1, comprising from 0.08% to 1.5% by dry weight of cationic sizing agent(s) relative to the total weight thereof.

9. The composition as claimed in claim 1, further comprising at least one mineral filler.

10. The composition as claimed in claim 1, comprising from 0.1% to 5% by weight of filler(s), relative to the total weight thereof.

11. The composition as claimed in claim 1, further comprising one or more bacteriostatic, bactericidal, fungistatic, fungicidal, levuricidal or virucidal agent other than a biocidal compound based on quaternary ammonium.

12. The composition as claimed in claim 1, comprising water.

13. A porous medium that has surface biocidal properties and has over all or part of at least one of its outer surfaces a surface treatment formed from a composition as claimed in claim 1.

14. The porous medium as claimed in claim 13, having a Cobb value of not more than 50 g/m² measured with the Cobb test carried out according to standard ISO 535:2014 over a period of 60 s.

15. The porous medium as claimed in claim 13, said porous medium being fibrous.

16. A process for producing a porous medium having surface biocidal properties as claimed in any of claim 13 comprising at least the steps of:
a) providing a porous substrate,
b) bringing all or part of at least one of the outer surfaces of said substrate into contact with a biocidal composition for the surface treatment of a porous substrate, comprising:
at least one hydrophilic binder,
at least one biocidal compound based on quaternary ammonium selected from non-polymeric quaternary ammonium salts of the following formula (CH₃)₂A₂N⁺X⁻, where:
A, which may be identical or different, represent linear C₆ to C₂₀ alkyl groups, and
X⁻ is an anion selected from halide anions and sulfonate anions, and
At least on cationic sizing agent under conditions conducive to forming a deposit of said composition thereon,
c) drying said deposit so as to form said porous medium provided with biocidal properties.

17. A method of conferring biocidal properties on a porous substrate or of boosting the hydrophobicity of a porous substrate, using a composition as claimed in claim 1.

18. (canceled)

19. A method of producing a banknote or a security sheet or a paper for printing, writing or copying or of producing a packaging cardboard, or of producing papers, nonwoven materials, and textiles, writing and printing papers, coated papers, and copying papers, using a porous material as claimed in claim 13.

20. (canceled)

21. (canceled)

22. The composition as claimed in claim 1, the cationic sizing agent being selected from alkenyl ketene dimers (AnKD), alkyl ketene dimers (AKD), styrene acrylates (SAE), rosins, alkenyl succinic anhydrides (ASA), and mixtures thereof.
